(19) United States
(12) Patent Application Publication
(10) Pub. No.: US 2026/0221116 A1
(43) Pub. Date: Jul. 30, 2026

(54) VOLTAGE SUPPLY DEVICE AND METHOD FOR DRIVING A DISPLAY

(71) Applicant: NXP B.V., Eindhoven (NL)

(72) Inventors: Yikun Mo, Suzhou (CN); Siyuan Chen, Suzhou (CN); Jie Jin, Suzhou (CN); Wenwei Jiang, Beijing (CN)

(21) Appl. No.: 19/458,047

(22) Filed: Jan. 23, 2026

(30) Foreign Application Priority Data
Jan. 24, 2025 (CN) 202510122401.2

(51) Int. Cl. G09G 3/36; G09G 3/18

(52) U.S. Cl. CPC G09G 3/3696; G09G 3/18; G09G 2310/0297

(57) ABSTRACT

Provided is a voltage supply device for a display. The voltage supply device includes a voltage supply unit and a controller unit. The voltage supply unit includes an input terminal, which receives a supply voltage, and includes a plurality of output terminals. A first output terminal of the plurality of output terminals provides a first output voltage level. A second output terminal of the plurality of output terminals provides a second output voltage level, and a third output voltage level, which is different from and subsequent to the second voltage level. The controller unit provides a control signal to the voltage supply unit. The voltage supply unit sets the second and third voltage levels in dependence on the control signal.

### BACKGROUND

The present disclosure relates to a voltage supply, and a method for supplying voltages for driving a display, and more specifically, an LCD (Liquid Crystal Display) segment display.

Most applications require stable supply voltages. For example, used in an LCD segment display driver circuit, voltages for driving display units may dominate the relative optical transmission of the LCD. Relative optical transmission of the LCD varies as a function of the driving voltage. Accordingly, the brightness as displayed by the LCD which is dependent on the relative optical transmission decreases as the driving voltage drops. If the LCD driver circuit is powered by a battery with which the supplied voltage decreases over time, the displayed brightness does not maintain the required level.

### SUMMARY

This summary is provided to introduce a selection of concepts in a simplified form that are further described below in the Detailed Description. This summary is not intended to identify key or essential features of the claimed subject matter, nor is it intended to be used to limit the scope of the claimed subject matter.

In one embodiment, there is provided a voltage supply device for a display. The voltage supply device includes a voltage supply unit and a controller unit. The voltage supply unit includes an input terminal which receives a supply voltage, and a plurality of output terminals. A first output terminal of the plurality of output terminals provides a first output voltage level. A second output terminal of the plurality of output terminals provides a second output voltage level, and a third output voltage level which is different from and subsequent to the second voltage level. The controller unit provides a control signal to the voltage supply unit. The voltage supply unit sets the second and third voltage levels in dependence on the control signal.

In another embodiment, there is provided d display system which includes a voltage supply device and a display. The voltage supply device includes an input terminal for receiving a supply voltage level, and multiple output terminals. The display receives a drive signal having a cycle including multiple intervals. The display operates in response to the drive signal. The drive signal has a first voltage level during a first interval of the cycle. The first voltage level is a first output voltage at a first output terminal of the multiple output terminals of the voltage supply device. The drive signal has a first pair of voltages including a second voltage level and a third voltage level during different periods of a second interval of the cycle. The third voltage level is different from the second voltage level. The second voltage level and the third voltage level are respectively a second output voltage and a third output voltage at a second output terminal of the multiple output terminals of the voltage supply device.

In yet another embodiment, there is provided a method for a voltage supply device to drive a display with a drive signal having more than one voltage during a cycle thereof. The method includes: providing, by the voltage supply device operating during a first period and at an output terminal, a first output voltage; providing, by the voltage supply device operating during a second period which is different from the first period, and at the output terminal, a second output voltage which is different from the first output voltage; providing the first output voltage and the second output voltage as a first portion of the drive signal to the display; and providing, from an additional output terminal of the voltage supply device, an additional output voltage as a second portion of the drive signal to the display.

### BRIEF DESCRIPTION OF THE DRAWINGS

So that the manner in which the above recited features of the present disclosure can be understood in detail, a more detailed description of the disclosure may be had by reference to embodiments, some of which are illustrated in the appended drawings. The appended drawings illustrate only typical embodiments of the disclosure and should not limit the scope of the disclosure, as the disclosure may have other equally effective embodiments. The drawings are for facilitating an understanding of the disclosure and thus are not necessarily drawn to scale. Advantages of the subject matter claimed will become apparent to those skilled in the art upon reading this description in conjunction with the accompanying drawings, in which like reference numerals have been used to designate like elements, and in which:

FIG. 1 is a block diagram of a voltage supply and a display supplied by the voltage supply according to an embodiment;

FIG. 2 is a schematic diagram of a voltage supply according to an embodiment.

FIG. 3 is a multi-voltage square wave diagram of a drive signal;

FIG. 4 is a multi-voltage square wave diagram of a drive signal according to an embodiment;

FIG. 5 is a multi-voltage square wave diagram of a drive signal according to an embodiment;

FIG. 6 are multi-voltage square wave diagrams of a drive signal and a common voltage signal according to an embodiment; and

FIG. 7 is a diagram showing the voltage difference between the drive signal and the common voltage signal of FIG. 6.

### DETAILED DESCRIPTION

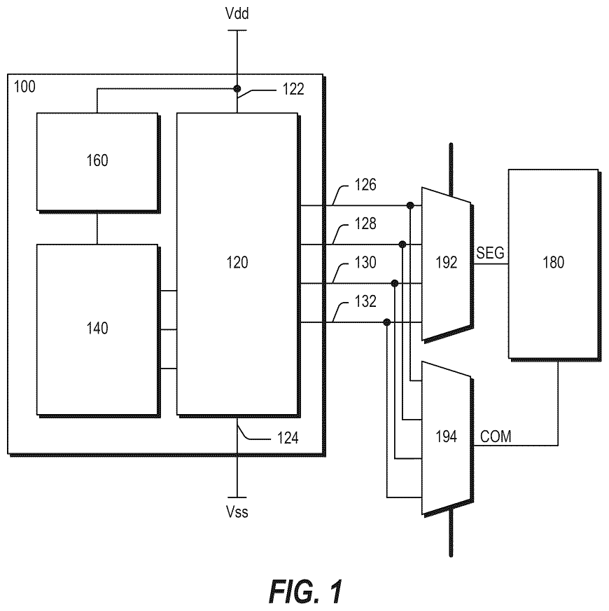

FIG. 1 is a block diagram of a voltage supply 100 and a display 180 supplied by the voltage supply according to an embodiment. The voltage supply 100, or voltage supply device 100, is coupled between a supply voltage V_{dd} and a ground voltage Vₛₛ. In the embodiment, the supply voltage V_{dd} may be supplied from a battery. The voltage supply 100 has a plurality of output terminals, each of which provides at least one output voltage to be supplied to the display 180 as a drive signal for driving the display 180. “At least one output voltage” means, for some of the output terminals, the voltage level of the output provided thereon may vary over time. In the embodiment of FIG. 1, a plurality of output voltages from the plurality of output terminals includes a first output voltage at the first output terminal 126 having a voltage level which is equal to the supply voltage V_{dd}, a first pair of output voltages at the second output terminal 128 and a second pair of output voltages at the third output terminal 130, the first pair of output voltages and second pair of output voltages are provided based on and, are functions of, the supply voltage V_{dd}, and a sixth output voltage at the fourth output terminal 132 having a voltage level which is equal to the ground voltage Vₛₛ.

The voltage supply 100 includes a voltage supply unit 120, a controller unit 140, and a sampler unit 160. The voltage supply unit 120 has an input terminal 122 for receiving the supply voltage V_{dd}, a grounding terminal 124 which is connected for the ground voltage Vₛₛ, and output terminals 126, 128, 130, and 132 that provide the plurality of output voltages. The controller unit 140 is connected to the voltage supply unit 120 for providing one or more control signals to the voltage supply unit 120. The voltage supply unit 120 produces from the received supply voltage V_{dd} the plurality of output voltages having the respective voltage levels, under the control of and as a response to the one or more control signals. Specifically, each of the output terminals 126, 128, 130, and 132 provides a corresponding output of the voltage supply unit 120, under the control of a corresponding control signal from the controller unit 140.

As described above, at least some of the output terminals are each configured to provide its output with the voltage level varies over time and consists of a pair of voltages. Output terminals 126 and 132 respectively provides the first output voltage which is equal to the supply voltage V_{dd} and the sixth output voltage which is equal to the ground voltage Vₛₛ. The other output terminals 128 and 130, which may be termed as being “in the middle”, respectively provide the first pair of output voltages and the second pair of output voltages. Using the control signals from the controller unit 140, the voltage supply unit 120 operates in a first period of operation and a second period of operation which is different from and, in some embodiments, immediately follows the first period of operation. The voltage supply unit 120 produces, from the supply voltage V_{dd} and at one of the output terminals, one of a respective pair of output voltages when operating during the first period, and another, different, voltage of the pair of output voltages when operating during the second period.

According to an embodiment, during the first period, also referred to as an “odd” period, a voltage level of the output provided at the second output terminal 128, also referred to as a second output voltage of the first pair of output voltages, is

$${V}_{ll 2 \_ odd} = \frac{2}{3} {V}_{d d} + ( {V}_{d d} - {V}_{th} ) \times {a}_{1} + {( {V}_{d d} - {V}_{th} )}^{2} \times {a}_{2} ,$$

wherein V_{ll2_odd} is the second output voltage, V_{dd} is the supply voltage, Vₜₕ is a threshold voltage, and a₁ and a₂ are predetermined factors. During this “odd” period, a voltage level of the output provided at the third output terminal 130, also referred to as a fourth output voltage of the second pair of output voltages, is half the second output voltage:

$${V}_{ll 1 \_ odd} = \frac{1}{2} {V}_{ll 2 \_ odd} ,$$

wherein V_{ll1_odd} is the fourth output voltage. According to the embodiment, Vₜₕ is a rated voltage of the supply voltage which, if the supply voltage is provided from a battery, is typically 3V, and may decrease gradually over time. In the embodiment, a₁ is 0.9, and a₂ is 0.3.

During the second period, also referred to as an “even” period, a voltage level of the output provided at the second output terminal 128, also referred to as a third output voltage of the first pair of output voltages, is

$${V}_{ll 2 \_ even} = \frac{2}{3} {V}_{d d} + ( {V}_{d d} - {V}_{th} ) \times {a}_{3} + {( {V}_{d d} - {V}_{th} )}^{2} \times {a}_{4} ,$$

wherein V_{ll2_even} is the third output voltage, V_{dd} is the supply output voltage, Vₜₕ is the threshold voltage, and a₃ and a₄ are predetermined factors. During the “even” period, a voltage level of the output provided at the third output terminal 130, also referred to as a fifth output voltage of the second pair of output voltages, is half the third output voltage:

$${V}_{ll 1 \_ even} = \frac{1}{2} {V}_{ll 2 \_ even} ,$$

wherein V_{ll1_even} is the fifth output voltage. According to the embodiment, a₃ is −0.9, and a₄ is −0.3. Thus, when the batter voltage is equal to its rated voltage (i.e. V_{dd}=Vₜₕ), the voltage levels of the pair of output voltages during the “odd” and “even” periods are equal:

$${V}_{ll 2 \_ even} = \frac{2}{3} {V}_{d d} = {V}_{ll 2 \_ odd} .$$

However when V_{dd} deviates from Vₜₕ, the the voltage levels of the pair of output voltages during the “odd” and “even” periods deviate from each other, wherein the deviation or “split” between the voltage levels during the “odd” and “even” periods is quadratically dependent on the deviation of V_{dd}.

In various embodiments, the display 180 is implemented as an LCD segment display including multiple segments. It is understood that the LCD display segment includes liquid crystal materials sandwiched between electrodes. Voltages applied on the electrodes produce an electric field therebetween, and drive the liquid crystal molecules to rotate, thus allowing light having an appropriate polarization to pass through. It is generally preferred to operate LCD displays using AC signals instead of DC signals, such that the liquid crystal molecules are not rotated for a time period too long, which would otherwise prevent them from recovering to the normal random distribution status. In various embodiments, the display 180 may also be implemented as “dot matrix” LCD displays. For driving the LCD display such as a segmented LCD display, one of the electrodes of the LCD segment is coupled with a common voltage signal COM, and the other electrode is supplied with a drive signal SEG. A voltage difference between the COM signal and the SEG signal varies, to avoid supplying a DC signal to the LCD segment. According to the embodiment, both the common voltage signal COM and the drive signal SEG are supplied by the voltage supply unit 120. The output terminals 126, 128, 130, and 132 are coupled to a first multiplexer 192 which selectively provide one of the outputs on one of the output terminals as the drive signal SEG. Similarly, the output terminals 126, 128, 130, and 132 are also coupled to a second multiplexer 194 which selectively provide one of the outputs on one of the output terminals as the common voltage signal COM.

According to an embodiment, the drive signal SEG applied to an electrode of the display 180 is a cyclic signal and has more than one voltages during a cycle thereof. The more than one voltages during the cycle is selected by the first multiplexer 192 from the outputs at the output terminals 126, 128, 130, and 132. That is to say, the output voltages on the output terminals 126, 128, 130, and 132 are selectively supplied to the display 180 to provide the one or more voltages during the cycle of the drive signal SEG. As described above, the fourth output voltage is half the second output voltage, and the fifth output voltage is half the third output voltage. Accordingly, the drive signal SEG may be configured to select relatively high voltages from the output terminals, so that the drive signal SEG has a Root Mean Square (RMS) equivalent voltage over its cycle higher than the turn-on threshold voltage, to turn on the coupled LCD display segment. On the other hand, the drive signal SEG may be configured to select relatively low voltages from the output terminals, so that the drive signal SEG has a Root Mean Square (RMS) equivalent voltage over the cycle lower than the turn-off threshold voltage, to turn off the coupled LCD display segment. According to the embodiment, the equivalent voltage is a Root Mean Square (RMS) value of the voltages of the drive signal SEG across a cycle thereof. Similarly, the other one of the electrodes of the display 180 is applied with a COM signal which is selected by the second multiplexer 194. The multiplexers 192 and 194 may be part of the voltage supply 100, of the display 180, or may, as shown, be a separate component or device.

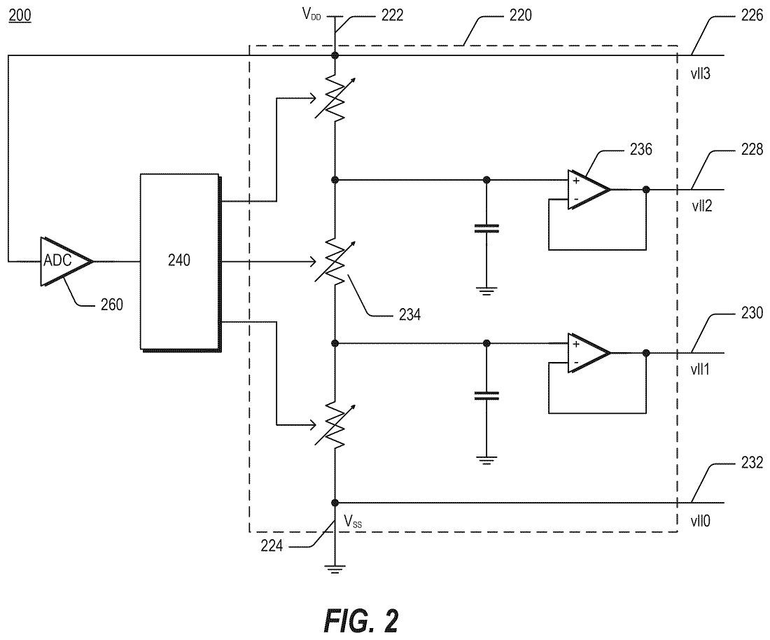

FIG. 2 is a schematic diagram of a voltage supply according to an embodiment. The voltage supply 200 may be an implementation of the voltage supply 100 of FIG. 1, and includes a voltage supply unit 220, a controller unit 240, and a sampler unit 260. The voltage supply unit 220 has an input terminal 222 for receiving the supply voltage V_{dd}, a grounding terminal 224 which is connected for the ground voltage Vₛₛ, and multiple output terminals 226, 228, 230, and 232 that provide a plurality of outputs vll3, vll2, vll1, and vll0. As described above, the voltage level of the first output vll3 equals to the supply voltage V_{dd}, and the voltage level of the fourth output vll0 equals to the ground voltage Vs. The voltage supply unit 220 according to the embodiment includes a resistor array which is configurable by the control signals provided by the controller unit 240. As shown in FIG. 2, the voltage supply unit 220 includes multiple resistor blocks 234 each of which receives a corresponding control signal from the controller unit 240. A voltage produced at a node between neighboring resistor blocks 234 is buffered by a buffer unit 236 of the voltage supply unit 220 before it is finally provided as the second output vll2 or the third output vll1. Similar to the embodiment of FIG. 1, the sampler unit 260 is an Analog to Digital Converter, ADC, in the embodiment of FIG. 2.

Operation of the voltage supply unit 220 under the control of the controller unit 240 is also similar to the embodiment of FIG. 1. The voltage supply unit 220, or to be more specific, the resistor blocks 234, are controlled to, at times, have a first configuration such that the voltage supply unit 220 operates during the first period, and are controlled to, at other times, have a second configuration such that the voltage supply unit 220 operates during the second period, so to provide the first pair of output voltages including the second output voltage V_{ll2_odd} and the third output voltage V_{ll2_even} provided at the output terminal 228, or the second pair of output voltages including the fourth output voltage V_{ll1_odd} and the fifth output voltage V_{ll1_even} provided at the output terminal 230, all of the output voltages are functions of the supply voltage V_{dd}.

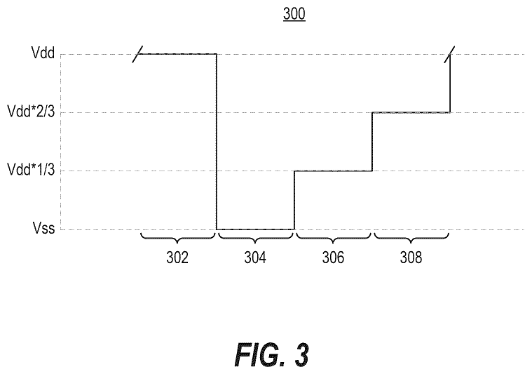

FIG. 3 is a multi-voltage square wave diagram of a drive signal SEG according to a conventional example. In the example, one of the electrodes of the coupled LCD display segment is supplied with the drive signal SEG 300, and the other electrode of the coupled LCD segment display is supplied with a common voltage signal COM having a ground voltage (which may be equal to Vₛₛ). FIG. 3 illustrates one cycle of the drive signal SEG 300. The cycle of the drive signal SEG 300 includes four intervals, respectively a first interval 302 during which the drive signal SEG has a voltage level of V_{dd}, a second interval 304 during which the drive signal SEG has a voltage level of Vₛₛ, a third interval 306 during which the drive signal SEG has a voltage level of

$$\frac{1}{3} {V}_{d d} ,$$

and a fourth interval 308 during which the drive signal SEG has a voltage level of

$$\frac{2}{3} {V}_{d d} .$$

Taking the voltage supply 100 of FIG. 1 as an example, the drive signal 300 may be supplied by the first output terminal 126 during the first interval 302, and may be supplied by the fourth output terminal 132 during the second interval 304. The drive signal 300 may be supplied by the third output terminal 130 during the third interval 306, and by the second output terminal 128 during the fourth interval 308.

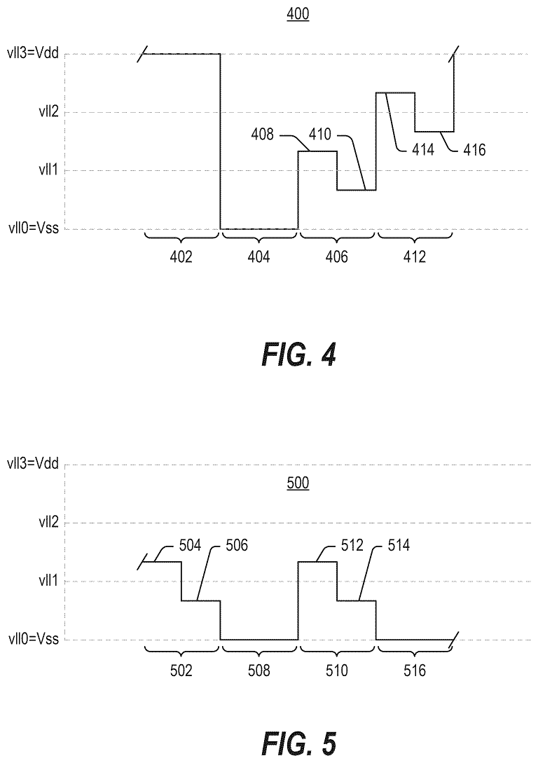

FIG. 4 is a multi-voltage square wave diagram of a drive signal SEG according to an embodiment. In the embodiment, one of the electrodes of the coupled LCD display segment is supplied with the drive signal 400, and the other electrode of the coupled LCD display segment is supplied with a signal COM having a ground voltage. The drive signal 400 of FIG. 4, showing only one cycle thereof, is configured to drive the coupled LCD display segment to operate in a first state, i.e. the turn-on state. As shown in FIG. 4, a cycle of the drive signal 400 includes four intervals. The third and fourth of the intervals are split into two parts, at different voltage levels. The intervals have equal lengths and are, respectively, a first interval 402 during which the drive signal 400 is supplied by the first output terminal 126 with a voltage level which equals to the supply voltage V_{dd}, a second interval 404 during which the drive signal 400 is supplied by the fourth output terminal 132 with a voltage level which equals to the ground voltage Vₛₛ, a third interval 406 during which the drive signal 400 is supplied by the third output terminal 130 with the second pair of output voltages including the fourth output voltage V_{ll1_odd} 408 and the fifth output voltage V_{ll1_even} 410, and a fourth interval 412 during which the drive signal 400 is supplied by the second output terminal 128 with the first pair of output voltages including the second output voltage V_{ll2_odd} 414 and the third output voltage V_{ll2_even} 416.

Referring back to FIG. 1, the first multiplexer 192 selectively provides one of the outputs on the output terminals 126, 128, 130, and 132 as the drive signal SEG. In detail, during the first interval 402, the first multiplexer 192 provides the first output on the first output terminal 126 as the drive signal SEG. Subsequently, during the second interval 404, the first multiplexer 192 provides the fourth output on the fourth output terminal 132 as the drive signal SEG. During the third interval 406, the first multiplexer 192 provides the third output on the third output terminal 130 as the drive signal SEG. As described above, during this third interval 406, the third output at the third output terminal 130 has the second pair of output voltages including the fourth output voltage 408 followed by the fifth output voltage 410, respectively generated by operating in the first period and the second period. Each of the first period and the second period lasts for half the third interval 406. Similarly, during the fourth interval 412, the first multiplexer 192 provides the second output on the second output terminal 128 as the drive signal SEG. As described above, during this fourth interval 412, the second output on the second output terminal 128 has the first pair of output voltages including the second output voltage 414 followed by the third output voltage 416, respectively generated by operating in the first period and the second period. Each of the first period and the second period lasts for half the fourth interval 412.

The drive signal SEG provided for the LCD segment display typically has a frequency in a range between 32 Hz and 256 Hz. Accordingly, the cycle of the drive signal SEG has a duration in a range between 1/32 seconds and 1/256 seconds. In the embodiment of FIG. 4, each interval is ¼ of the cycle duration of the drive signal, and the first and second periods each lasts for half the interval. That is to say, each output voltage of the first and second pairs of output voltages on the corresponding output terminals lasts for half the interval. The intervals during a cycle of the drive signal, or the output voltages, may have different duration allocations, but at the cost of the consumption of controlling resources.

According to the embodiment of FIG. 4, an equivalent voltage of the drive signal 400 during the cycle thereof is:

$${V}_{o n ( R M S )} = \frac{\sqrt{{V}_{ll 3}^{2} + {( {V}_{ll 3} - {V}_{ll 2 \_ odd} )}^{2} + {( {V}_{ll 2 \_ even} - {V}_{ll 1 \_ even} )}^{2} + {V}_{ll 1 \_ even}^{2}}}{\sqrt{n m u x}} ,$$

wherein V_{on(RMS)} is the equivalent voltage and in this embodiment higher than a turn-on threshold voltage for turning on the coupled LCD display segment, and nmux is an amount of output terminals of the voltage supply unit 120 and in this embodiment is 4.

FIG. 5, on the other hand, is a multi-voltage square wave diagram of a drive signal according to an embodiment. Similar to that of FIG. 4, in this embodiment, one of the electrodes of the coupled LCD display segment is supplied with the drive signal 500, and the other electrode of the coupled LCD display segment is supplied with a signal COM having a ground voltage. The drive signal 500 of FIG. 5, showing only one cycle thereof, is configured to drive the coupled LCD display segment to operate in a second state, i.e. the turn-off state. As shown in FIG. 5, a cycle of the drive signal 500 includes four intervals, respectively a first interval 502 during which the drive signal 500 is supplied by the third output terminal 130 with the second pair of output voltages including the fourth output voltage V_{ll1_odd} 504 and the fifth output voltage V_{ll1_even} 506, a second interval 508 during which the drive signal 500 is supplied by the fourth output terminal 132 with a voltage level which equals to the ground voltage Vₛₛ, a third interval 510 during which the drive signal 500 is again supplied by the third output terminal 130 with the second pair of output voltages including the fourth output voltage V_{ll1_odd} 512 and the fifth output voltage V_{ll1_even} 514, and a fourth interval 516 during which the drive signal 500 is again supplied by the fourth output terminal 132 with a voltage level which equals to the ground voltage Vₛₛ. Accordingly, an equivalent voltage of the drive signal 500 during the cycle thereof is

$${V}_{o f f ( R M S )} = \frac{\sqrt{( n m u x - 1 ) \times {( {V}_{ll 2 \_ odd} - {V}_{ll 1 \_ odd} )}^{2} + {V}_{ll 1 \_ odd}^{2}}}{\sqrt{n m u x}} ,$$

wherein V_{off(RMS)} is the equivalent voltage and in this embodiment lower than a turn-off threshold voltage for turning off the coupled LCD display segment, and nmux is an amount of output terminals of the voltage supply unit 120 and in this embodiment is 4.

The examples of FIG. 4 and FIG. 5 are not limiting, other embodiments may include the output at one of the output terminals having the corresponding pair of output voltages respectively produced during the first and second periods as a first portion of the drive signal during a first interval of its cycle, and include the output at another one of the output terminals having its corresponding pair of output voltages as a second portion of the drive signal during a second interval of its cycle, such that the drive signal provided to drive the LCD display is not a DC signal. The drive signal SEG supplied to the LCD display shall have at least a voltage level of the supply voltage V_{dd} and last for at least a duration in its cycle, which duration is ¼ of the cycle in the example of FIG. 4, such that the LCD display is turned on. On the other hand, the drive signal SEG supplied to the LCD display shall not have a voltage of the supply voltage V_{dd}, such that the LCD display is turned off.

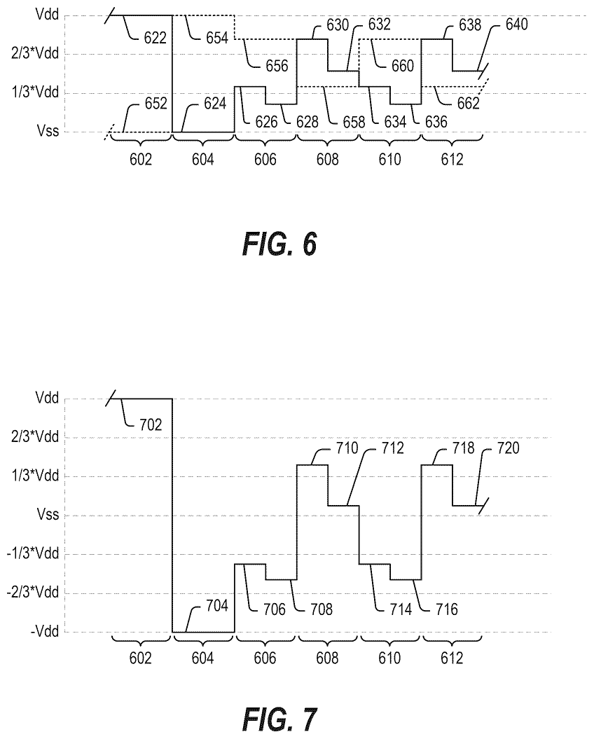

FIG. 6 shows square wave diagrams of the common voltage signal COM (dotted) and the drive signal SEG (solid) applied to electrodes of an LCD display segment according to an embodiment, having six intervals, some of which are split into two parts. Different from the examples of FIG. 4 and FIG. 5, both the SEG signal and the COM signal according to this embodiment have varying voltages during an interval. The embodiment of FIG. 6 may have a supply voltage, e.g. a battery voltage, of 2.4V. During a first interval 602, the drive signal SEG of the embodiment has a first voltage level 622 which is equal to the supply voltage V_{dd} which is 2.4V During a subsequent second interval 604, the drive signal SEG has a second voltage level 624 which equals the ground voltage Vₛₛ which is 0V. Subsequently, during a third interval 606, the drive signal SEG has a third voltage 626 followed by a fourth voltage 628, each for a part of the interval, and specifically, each for half of the third interval 606. As described above, the third voltage 626 and the fourth voltage 628 are provided by the voltage supply unit, based on the supply voltage V_{dd}, respectively produced during the first period and the second period. In the example, the third voltage 626 is 0.98V, and the fourth voltage 628 is 0.62V During a fourth interval 608, the drive signal SEG has a fifth voltage 630 followed by a sixth voltage 632 that are similarly both provided by the voltage supply unit, and produced during the first and second periods. In the example, the fifth voltage 630 is 1.96V, and the sixth voltage 632 is 1.24V. Then, during a fifth interval 610, the drive signal SEG has a seventh voltage 634 followed by an eighth voltage 636 that are equal to the third voltage 626 and the fourth voltage 628, respectively. During a last, sixth, interval 612, the drive signal SEG has a ninth voltage 638 followed by a tenth voltage 640 that are respectively equal to the fifth voltage 630 and the sixth voltage 632.

During the first interval 602, the common voltage signal COM of the embodiment has a first voltage level 652 which equals the ground voltage Vₛₛ, and is 0V. Subsequently, during the second interval 604, the common voltage signal COM has a second voltage level 654 which equals the supply voltage V_{dd}, and is 2.4V. During the third interval 606, the common voltage signal COM has a third voltage level 656 which is provided based on the supply voltage V_{dd}, and in this embodiment is 1.24V. The common voltage signal COM has a fourth voltage level 658 of 0.62V during the fourth interval 608, and a fifth voltage level 660 during the fifth interval 610. In the embodiment, the fifth voltage level 660 equals the third voltage level 656 and is also 1.24V Similarly, the following sixth voltage level 662 of the common voltage signal COM during the sixth interval 612 is equal to the fourth voltage level 658 and is also 0.62V.

Similar to the embodiment of FIG. 1, the first voltage 622 of the drive signal SEG is supplied by the first output terminal 126 during the first interval 602, and the second voltage 624 of the drive signal SEG is supplied by the fourth output terminal 132 during the second interval 604. As described above, the first output terminal 126 provides the first output with the first output voltage which is equal to the supply voltage V_{dd}, and the fourth output terminal 132 provides the fourth output with the sixth output voltage which equals the ground voltage Vₛₛ. The third voltage 626 and then the fourth voltage 628 of the drive signal SEG are supplied by the third output terminal 130 during the third interval 606. As described, the third output terminal 130 provides the second pair of output voltages including the fourth output voltage V_{ll1_odd} during the first period, the “odd” period, as:

$${V}_{ll 1 \_ odd} = \frac{1}{2} {V}_{ll 2 \_ odd} ,$$

and the fifth output voltage V_{ll1_even} during the second period, the “even” period, as

$${V}_{ll 1 \_ even} = \frac{1}{2} {V}_{ll 2 \_ even} .$$

The fifth voltage 630 and then the sixth voltage 632 of the drive signal SEG are supplied by the second output terminal 128 during the fourth interval 608. Similarly, the second output terminal 128 provides the first pair of output voltages including the second output voltage V_{ll2_odd} during the first period, the “odd” phase, as:

$${V}_{ll 2 \_ odd} = \frac{2}{3} {V}_{dd} + ( {V}_{dd} - {v}_{th} ) \times {a}_{1} + {( {V}_{dd} - {V}_{th} )}^{2} \times {a}_{2} ,$$

and the third output voltage V_{ll2_even} during the second period, the “even” phase, as:

$${V}_{ll 2 \_ even} = \frac{2}{3} {V}_{dd} + ( {V}_{dd} - {v}_{th} ) \times {a}_{3} + {( {V}_{dd} - {V}_{th} )}^{2} \times {a}_{4} .$$

In this embodiment, the factors are: a₁=−0.6, a₂=0, a₃=0.6, and a₄=0. The seventh voltage 634 and then the eighth voltage 636 of the drive signal SEG are supplied by the third output terminal 130 during the fifth interval 610. Similarly, the ninth voltage 638 and the tenth voltage 640 of the drive signal SEG are supplied by the second output terminal 128 during the sixth interval 612.

For the common voltage signal COM, the first voltage 652 during the first interval 602 is supplied by the output at the fourth output terminal 132, and the second voltage 654 during the second interval 604 is supplied by the output at the first output terminal 126. The third voltage 656 of the common voltage signal COM during the third interval 606 and the fifth voltage 660 during the fifth interval 610 are supplied by the second output voltage V_{ll2_odd} of the first pair of output voltages at the second output terminal 128. The fourth voltage 658 during the fourth interval 608 and the sixth voltage 662 during the sixth interval 612 are supplied by the fourth output voltage V_{ll1_odd} of the second pair of output voltages at the third output terminal 130.

Referring back to FIG. 1, the second multiplexer 194 selectively provides one of the outputs on the output terminals 126, 128, 130, and 132 as the common voltage signal COM, as will be described, interval by interval. In detail, during the first interval 602, the second multiplexer 194 provides the fourth output on the fourth output terminal 132 as the common voltage signal COM. Subsequently, during the second interval 604, the second multiplexer 194 selects the first output on the first output terminal 126 to be provided as the common voltage signal COM.

During the third interval 606, the second multiplexer 194 selects the second output on the second output terminal 128 to be provided as the common voltage signal COM. During this third interval 606, the second output terminal 128 provides the second output voltage V_{ll2_odd} followed by the third output voltage V_{ll2_even}, respectively generated during the first and second periods. However, it will be seen from FIG. 6 that, during the whole of the third interval 606, the common voltage signal COM is set at the second output voltage V_{ll2_odd}. The second multiplexer 194 is switched off during the second half of the third interval 606, and an output of the second multiplexer 194 is held at the voltage level which was output during the first half of the third interval 606. Thus, the voltage level of the common voltage signal COM is kept as the second output voltage V_{ll2_odd}.

Similarly, during the fourth interval 608, the second multiplexer 194 selects the third output on the third output terminal 130 to be provided as the common voltage signal COM. During this fourth interval 608, the third output terminal 130 provides the fourth output voltage V_{ll1_odd} followed by the fifth output voltage V_{ll1_even}, respectively generated during the first and second periods. However, it is shown in FIG. 6 that, during the whole of the fourth interval 608, the common voltage signal COM is set at the fourth output voltage V_{ll1_odd}. The second multiplexer 194 is switched off during the second half of the fourth interval 608, and the output of the second multiplexer 194 is held at the voltage level which was previously provided during the first half of the fourth interval 608. Thus, the voltage level of the common voltage signal COM is kept as the fourth output voltage V_{ll1_odd}.

The common voltage signal COM during the fifth interval 610 is selected by the second multiplexer 194 in a manner similar to that during the third interval 606, and the common voltage signal COM during the sixth interval 612 is selected by the second multiplexer 194 in a manner similar to that during the fourth interval 608.

As a result of the drive signal SEG and the common voltage signal COM both have varying voltage levels, voltage differences between electrodes of the LCD display segment also vary. FIG. 7 shows a diagram of the voltage difference across the LCD display segment when supplied with the drive signal SEG and the common voltage signal COM of FIG. 6. Below is a table showing the voltages of the drive signal SEG, the common voltage signal COM, and the voltage differences therebetween:

| | PO (602) | | P1 (604) | | P2 (606) | | P3 (608) | | P4 (610) | | P5 (612) | |
|---|---|---|---|---|---|---|---|---|---|---|---|---|
| | odd | even | odd | even | odd | even | odd | even | odd | even | odd | even |
| COM | 0 | 0 | 2.4 | 2.4 | 1.96 | 1.96 | 0.98 | 0.98 | 1.96 | 1.96 | 0.98 | 0.98 |
| SEG | 2.4 | 2.4 | 0 | 0 | 0.98 | 0.62 | 1.96 | 1.24 | 0.98 | 0.62 | 1.96 | 1.24 |
| SEG- | 2.4 | 2.4 | −2.4 | −2.4 | −0.98 | −1.34 | 0.98 | 0.26 | −0.98 | −1.34 | 0.98 | 0.26 |
| COM | | | | | | | | | | | | |

In the table, P0 to P5 are the intervals of the cycle of the signals COM and SEG. Referring to FIG. 7, the voltage difference 702 during the first interval 602 is +2.4V, and the voltage difference 704 during the second interval 604 is −2.4V During the third interval 606, in the first, odd, period, the voltage difference 706 is −0.98V, and in the second, even, period, the voltage difference 708 is −1.34V During the fourth interval 608, in the first period, the voltage difference 710 is 0.98V, and the voltage difference 712 is 0.26V during the second period. Similarly, during the fifth interval 610, the voltage difference 714 is −0.98V during the first period, and the voltage difference 716 is −1.34V during the second period. During the sixth interval 612, the voltage difference 718 is 0.98V during the first period, and the voltage difference 720 is 0.26V during the second period.

Accordingly, an equivalent voltage for turning on the LCD display segment, which is the equivalent voltage of the voltage differences between the drive signal SEG and the common voltage signal COM when applied to the LCD display segment for turning on the display, during the cycle thereof is:

$${V}_{on ( RMS )} = \frac{\sqrt{{V}_{ll 3}^{2} + {( {V}_{ll 3} - {V}_{ll 2 \_ odd} )}^{2} + \frac{{( {V}_{ll 2 \_ odd} - {V}_{ll 1 \_ odd} )}^{2}}{2} + \frac{{( {V}_{ll 2 \_ even} - {V}_{ll 1 \_ odd} )}^{2}}{2} + \frac{{V}_{ll 1 \_ odd}^{2}}{2} + \frac{{V}_{ll 1 \_ even}^{2}}{2}}}{\sqrt{nmux}} ,$$

wherein V_{on(RMS)} is the equivalent voltage and in this embodiment higher than a turn-on voltage for turning on the coupled LCD display segment, and nmux is an amount of output terminals of the voltage supply unit 120 and in this embodiment is 4.

According to an example, an equivalent voltage for turning off the LCD display segment, which is the equivalent voltage of the voltage differences between the drive signal SEG and the common voltage signal COM when applied to the LCD segment display for turning off the display, during a cycle having six interval thereof is:

$${V}_{off ( RMS )} = \frac{\sqrt{{( {V}_{ll 3} - {V}_{ll 2 \_ odd} )}^{2} + \frac{{( {V}_{ll 2 \_ odd} - {V}_{ll 1 \_ odd} )}^{2}}{2} + \frac{{( {V}_{ll 2 \_ even} - {V}_{ll 1 \_ odd} )}^{2}}{2} + \frac{{( {V}_{ll 1 \_ odd} - {V}_{ll 2 \_ odd} )}^{2}}{2} + \frac{{( {V}_{ll 1 \_ even} - {V}_{ll 2 \_ odd} )}^{2}}{2} + \frac{{V}_{ll 1 \_ odd}^{2}}{2} + \frac{{V}_{ll 1 \_ even}^{2}}{2}}}{\sqrt{nmux}} ,$$

wherein V_{off(RMS)} is the equivalent voltage and in the embodiment lower than a turn-off voltage for turning off the coupled LCD segment display, and nmux is an amount of output terminals of the voltage supply unit 120 and in the embodiment may be 4.

A conventional voltage supply may use a voltage divider which includes resistors connected in series to divide the supply voltage, and output voltages at nodes between the resistors. As can be understood, the output voltages may gradually decrease as the supply voltage, for example supplied from a battery, decreases over time. The output voltages, when provided to the LCD display, may decrease below the turn-on threshold voltage of the display such that the display may not display properly. According to the examples, both the turn-on equivalent voltage and the turn-off equivalent voltage vary at a small rate with the variation of the supply voltage, meaning that the turn-on equivalent voltage and the turn-off equivalent voltage keep relatively stable against the varying supply voltage. The LCD display thus supplied can maintain a high relative transmission rate when turning on, and a low relative transmission rate when turning off, and can avoid the gray display due to under-supplied turn-on voltage or over-supplied turn-off voltage.

Referring back to FIG. 1, the sampler unit 160 of the voltage supply 100 is coupled to receive the supply voltage V_{dd}. The sampler unit 160 samples the supply voltage V_{dd}, and generates a digital signal with a digital value that is indicative of the sampled supply voltage V_{dd}. The sampler unit 160 is also coupled with the controller unit 140 to provide the generated digital signals to the controller unit 140. The controller unit 140 uses the digital signal to generate the one or more control signal to be provided to the voltage supply unit 120, such that the voltages of the plurality of outputs vll3, vll2, vll1, and vll0, as described above, are functions of the supply voltage V_{dd}. In the embodiment, the sampler unit 160 is an analog-to-digital converter (ADC). By sampling the supply voltage V_{dd} and controlling the voltage supply unit 120 using control signals generated based on the sampled supply voltage, the voltages of the plurality of outputs vll3, vll2, vll1, and vll0 may be precisely provided.

Referring to FIG. 2, the multiple resistor blocks 234 connected between the input terminal 222 and the grounding terminal 224 may be implemented as a voltage divider which includes a plurality of resistors that are connected in series. Nodes between the resistors have voltages between the supply voltage V_{dd} and the ground voltage V. Each resistor is connected with a corresponding switch which is controlled by a corresponding control signal from the controller unit 240, to provide node voltages at the nodes ready to be provided for the output terminals 226, 228, 230, and 232. Using the sampled supply voltage, the controller unit 240 may accurately know which voltage amongst the node voltages shall be provided as the output voltage, and the generated control signal is dynamic to the variations of the supply voltage V_{dd}.

The use of the terms “a” and “an” and “the” and similar referents in the context of describing the subject matter (particularly in the context of the following claims) are to be construed to cover both the singular and the plural, unless otherwise indicated herein or clearly contradicted by context. The terms “coupled” and “connected” both mean that there is an electrical connection between the elements being coupled or connected, and neither implies that there are no intervening elements. Recitation of ranges of values herein are intended merely to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the disclosure as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1-20. (canceled)

21. A voltage supply device for a display and comprising:
a voltage supply unit comprising:
an input terminal configured to receive a supply voltage; and
a plurality of output terminals including a first output terminal and a second output terminal, the first output terminal configured to provide a first voltage level, the second output terminal configured to provide a second voltage level and to provide a third voltage level different from and subsequent to the second voltage level; and
a controller unit configured to provide a control signal to the voltage supply unit; and
wherein the voltage supply unit is configured to set the second and third voltage levels in dependence on the control signal.

22. The voltage supply device of claim 21, further comprising:
a sampler unit configured to sample the supply voltage and generate a digital value that is indicative of the sampled supply voltage; and
wherein the controller unit is configured to receive the digital value and provide the control signal to the voltage supply unit such that the second voltage level and the third voltage level are functions of the sampled supply voltage.

23. The voltage supply device of claim 21, wherein the voltage supply unit further comprises:
a third output terminal of the plurality of the output terminals configured to provide a fourth voltage level and to provide a fifth voltage level different from and subsequent to the fourth voltage level; and
wherein the voltage supply unit is further configured to set the fourth and fifth voltage levels in dependence on the control signal.

24. The voltage supply device of claim 23, wherein the second output terminal is configured to provide the second voltage level as:
$${V}_{ll {2}_{odd}} = \frac{2}{3} {V}_{dd} + ( {V}_{dd} - {V}_{th} ) \times {a}_{1} + {( {V}_{dd} - {V}_{th} )}^{2} \times {a}_{2} ,$$
wherein Vₗₗ₂_{_{odd}} is the second voltage level, V_{dd} is the supply voltage, Vₜₕ is a threshold voltage, and a₁ and a₂ are predetermined factors; and
the third output terminal is configured to provide the fourth voltage level as:
$${V}_{ll {1}_{odd}} = \frac{1}{2} {V}_{ll {2}_{odd}} ,$$
wherein Vₗₗ₁_{_{odd}} is the fourth voltage level.

25. The voltage supply device of claim 24, wherein Vₜₕ is a rated voltage of the supply voltage, and a₁ is 0.9, and a₂ is 0.3.

26. The voltage supply device of claim 23, wherein the second output terminal is configured to provide the third voltage level as:
$${V}_{ll {2}_{even}} = \frac{2}{3} {V}_{dd} + ( {V}_{dd} - {V}_{th} ) \times {a}_{3} + {( {V}_{dd} - {V}_{th} )}^{2} \times {a}_{4} ,$$
wherein Vₗₗ₂_{ₑᵥₑₙ} is the third voltage level, V_{dd} is the supply voltage, Vₜₕ is a threshold voltage, and a₃ and a₄ are predetermined factors; and
the third output terminal is configured to provide the fifth voltage level as:
$${V}_{ll {1}_{even}} = \frac{1}{2} {V}_{ll {2}_{even}} ,$$
wherein Vₗₗ₁_{ₑᵥₑₙ} is the fifth voltage level.

27. The voltage supply device of claim 26, wherein Vₜₕ is a rated voltage of the supply voltage, and a₃ is −0.9, and a₄ is −0.3.

28. A display system comprising:
a voltage supply device comprising:
an input terminal for receiving a supply voltage level;
and multiple output terminals; and
a display configured to receive a drive signal having a cycle comprising multiple intervals, the display is configured to operate in response to the drive signal, wherein the drive signal includes:
a first voltage level during a first interval of the cycle, the first voltage level including a first output voltage at a first output terminal of the multiple output terminals of the voltage supply device, and
a first pair of voltages comprising a second voltage level and a third voltage level that is different from the second voltage level; and
wherein, during different periods of a second interval of the cycle, the second voltage level includes a second output voltage and the third voltage level includes a third output voltage at a second output terminal of the multiple output terminals of the voltage supply device.

29. The display system of claim 28, wherein the display is further configured to operate in response to the drive signal having a second pair of voltages comprising:
a fourth voltage level and a fifth voltage level that is different from the fourth voltage level; and
wherein, during different periods of a third interval of the cycle, the fourth voltage level includes a fourth output voltage and the fifth voltage level includes a fifth output voltage at a third output terminal of the multiple output terminals of the voltage supply device.

30. The display system of claim 29, wherein:
the first pair of voltages of the drive signal during the second interval of the cycle are:
the second voltage level, Vₗₗ₂_{_{odd}}, defined according to:
$${V}_{ll {2}_{odd}} = \frac{2}{3} {V}_{dd} + ( {V}_{dd} - {V}_{th} ) \times {a}_{1} + {( {V}_{dd} - {V}_{th} )}^{2} \times {a}_{2} ,$$
wherein V_{dd} is a supply voltage, Vₜₕ is a threshold voltage, and a₁ and a₂ are predetermined factors; and
the third voltage level, Vₗₗ₂_{ₑᵥₑₙ}, defined according to:
$${V}_{ll {2}_{even}} = \frac{2}{3} {V}_{dd} + ( {V}_{dd} - {V}_{th} ) \times {a}_{3} + {( {V}_{dd} - {V}_{th} )}^{2} \times {a}_{4} ,$$
wherein a₃ and a₄ are predetermined factors;
and wherein the second pair of voltages of the drive signal during the third interval of the cycle are:
the fourth voltage level, being half the second voltage level; and
the fifth voltage level, being half the third voltage level.

31. The display system of claim 29, wherein the display is further configured to operate in response to the drive signal including a sixth voltage level during a fourth interval of the cycle, the sixth voltage level including a sixth output voltage at a fourth output terminal of the multiple output terminals of the voltage supply device.

32. The display system of claim 31, wherein the first voltage level of the drive signal equals the supply voltage, and the sixth voltage level of the drive signal equals a ground voltage.

33. The display system of claim 28, wherein the voltage supply device comprises:
a controller unit configured to provide a control signal; and
a voltage supply unit configured to, in response to the control signal from the controller unit, provide output voltages at the multiple output terminals.

34. The display system of claim 33, wherein the voltage supply device further comprises:
a sampler unit configured to sample a supply voltage and produce a digital signal indicative of the sampled supply voltage; and
wherein the controller unit is configured to provide the control signal based on the digital signal from the sampler unit.

35. A method for a voltage supply device to drive a display with a drive signal having more than one voltage during a cycle thereof, the method comprising:
providing, by the voltage supply device operating during a first period and at an output terminal, a first output voltage;
providing, by the voltage supply device operating during a second period, different from the first period, and at the output terminal, a second output voltage different from the first output voltage;
providing the first output voltage and the second output voltage as a first portion of the drive signal to the display; and
providing, from an additional output terminal of the voltage supply device, an additional output voltage as a second portion of the drive signal to the display.

36. The method of claim 35, wherein:
the first output voltage, Vₗₗ₂_{_{odd}}, is defined by:
$${V}_{ll {2}_{odd}} = \frac{2}{3} {V}_{dd} + ( {V}_{dd} - {V}_{th} ) \times {a}_{1} + {( {V}_{dd} - {V}_{th} )}^{2} \times {a}_{2} ,$$
wherein V_{dd} is a supply voltage, Vₜₕ is a threshold voltage, and a₁ and a₂ are predetermined factors; and
the second output voltage, Vₗₗ₂_{ₑᵥₑₙ}, is defined by:
$${V}_{ll {2}_{even}} = \frac{2}{3} {V}_{dd} + ( {V}_{dd} - {V}_{th} ) \times {a}_{3} + {( {V}_{dd} - {V}_{th} )}^{2} \times {a}_{4} ,$$
wherein a₃ and a₄ are predetermined factors.

37. The method of claim 36, wherein providing the additional output voltage as the second portion of the drive signal comprises:
providing, by the voltage supply device operating during the first period and at the additional output terminal, a third output voltage of:
$${V}_{ll {1}_{odd}} = \frac{1}{2} {V}_{ll {2}_{odd}} , wherein {V}_{ll {1}_{odd}}$$
is the third output voltage; and
providing, by the voltage supply device operating during the second period and at the additional output terminal, a fourth output voltage, different from the third output voltage, of:
$${V}_{ll {1}_{even}} = \frac{1}{2} {V}_{ll {2}_{even}} , wherein {V}_{ll {1}_{even}}$$
is the fourth output voltage.

38. The method of claim 35, wherein additional output voltage is a ground voltage.

39. The method of claim 35, wherein the drive signal comprises:
during one cycle thereof, at least the provided first output voltage and the second output voltage as the first portion of the cycle of the drive signal; and
the additional output voltage as the second portion of the cycle of the drive signal.

40. The method of claim 39, further comprising:
turning on the display in response to an equivalent voltage of the drive signal being higher than a turn-on threshold voltage of the display; and
turning off the display in response to an equivalent voltage of the drive signal being lower than a turn-off threshold voltage of the display; and wherein
the equivalent voltage of the drive signal is a root mean square value of voltages of the drive signal during the cycle thereof.
